(19) United States
(12) Patent Application Publication
(10) Pub. No.: US 2021/0039196 A1
(43) Pub. Date: Feb. 11, 2021

(54) LASER PROCESSING DEVICE FOR MAKING METROLOGICAL SCALE

(71) Applicant: Chun-Hao LI, Taipei City (TW)

(72) Inventor: Chun-Hao LI, Taipei City (TW)

(21) Appl. No.: 16/576,190

(22) Filed: Sep. 19, 2019

(30) Foreign Application Priority Data
Aug. 7, 2019 (TW) 108210476

(51) Int. Cl. B23K 26/062; B23K 26/082; B23K 26/364

(52) U.S. Cl. CPC B23K 26/062; B23K 26/032; B23K 26/364; B23K 26/082

(57) ABSTRACT

A laser processing device for making a metrological scale includes a laser unit, a motion platform, and a control unit. The laser unit is configured to output a laser beam. The motion platform bears the laser unit. The control unit is electrically connected to the laser unit and the motion platform, to control the motion platform to move relative to the workpiece and trigger the laser unit to output the laser beam at a suitable location, so that the workpiece is processed with a plurality of scale lines.

### CROSS-REFERENCE TO RELATED APPLICATION

This non-provisional application claims priority under 35 U.S.C. § 119(a) to Patent Application No. 108210476 filed in Taiwan, R.O.C. on Aug. 7, 2019, the entire contents of which are hereby incorporated by reference.

### BACKGROUND

### Technical Field

The present invention relates to a processing device, and in particular, to a laser processing device for making a metrological scale.

### Related Art

A precision machining instrument usually needs a precise and accurate scale as a measurement benchmark. A precision rotary device (such as a motor) also needs a precise and accurate pitch gauge for measurement. The measurements require high accuracy, and how to make the measurement scales quickly and accurately becomes the only major issue.

### SUMMARY

In view of this, an embodiment of the present invention provides a laser processing device for making a metrological scale, and the laser processing device includes a laser unit, a motion platform, and a control unit. The laser unit is configured to output a laser beam. The motion platform bears the laser unit. The control unit is electrically connected to the laser unit and the motion platform, to control the motion platform to move relative to a workpiece and trigger the laser unit to output the laser beam at the suitable location, so that the workpiece is processed with a plurality of scale lines.

In some embodiments, the laser processing device has a processing area, the workpiece is a strip, and the laser processing device further includes a conveyor wheel set. The conveyor wheel set is electrically connected to the control unit for conveying the strip to pass through the processing area, so that a segment of the strip located in the processing area is processed with the scale lines.

In some embodiments, the laser beam forms the scale lines in a direct writing manner.

In some embodiments, the laser unit outputs the laser beam in a scanning manner to form one scale line during each scan, and moves to a location of a next scale line through the motion platform.

In some embodiments, the laser processing device further includes a mask disposed in the processing area, so that the workpiece is processed by a portion of the laser beam passing through the mask.

In some embodiments, the laser beam is a deep ultraviolet laser beam.

In some embodiments, the laser processing device further includes a visual alignment module electrically connected to the control unit, to obtain an image of the processing area for the control unit to align the next segment.

In some embodiments, the laser processing device further includes a suction device electrically connected to the control unit, to fasten the segment of the strip by suction.

In some embodiments, the laser processing device further includes a double-sided laminating wheel set electrically connected to the control unit. The conveyor wheel set conveys a processed segment of the strip out of the processing area, and the double-sided laminating wheel set separately applies a laminar film on a side surface and an opposite side surface that have the scale lines and that are on the segment of the strip out of the processing area.

In some embodiments, the laminar film on the side surface having the scale lines is a protection film.

In some embodiments, the laminar film on the opposite side surface having the scale lines is an adhesive film.

In some embodiments, the scale lines are in a parallel alignment.

In some embodiments, the scale lines are in a radial alignment.

Based on the above, the embodiments of the present invention provide a laser processing device for making a metrological scale, to accurately process the workpiece.

### BRIEF DESCRIPTION OF THE DRAWINGS

FIG. 1 is a schematic architectural diagram of a laser processing device for making a metrological scale according to an embodiment of the present invention;

FIG. 2 is a partially enlarged schematic diagram of a strip-shaped workpiece according to an embodiment of the present invention;

FIG. 3 is a top view of a disc-shaped workpiece according to an embodiment of the present invention; and

FIG. 4 is a schematic architectural diagram of a laser processing device for making a metrological scale according to another embodiment of the present invention.

### DETAILED DESCRIPTION

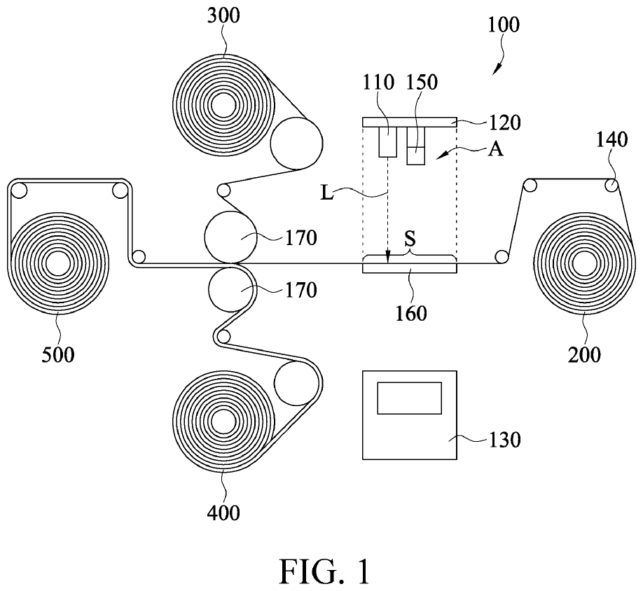

FIG. 1 is a schematic architectural diagram of a laser processing device 100 for making a metrological scale according to an embodiment of the present invention. The metrological scale may be a length metrological scale, or may be an angular metrological scale. The laser processing device 100 has a processing area A adapted to process a workpiece 200. The laser processing device 100 includes a laser unit 110, a motion platform 120 and a control unit 130. The laser unit 110 is configured to output a laser beam L. The motion platform 120 bears the laser unit 110. For example, the control unit 130 may be a control machine electrically connected to the laser unit 110 and the motion platform 120, to control the motion platform 120 to move relative to the workpiece 200 and trigger the laser unit 110 to output the laser beam L at a suitable location, so that the workpiece 200 is processed.

An example in which the workpiece 200 is a strip is used herein. The laser processing device 100 further includes a conveyor wheel set 140 formed by a plurality of scroll wheels, to convey the strip-shaped workpiece 200. The conveyor wheel set 140 is electrically connected to the control unit 130, to be controlled by the control unit 130 to move forward or backward. Therefore, the strip-shaped workpiece 200 can be conveyed to pass through the processing area A, so that a segment S of the strip-shaped workpiece 200 located in the processing area A can be processed by the laser beam L.

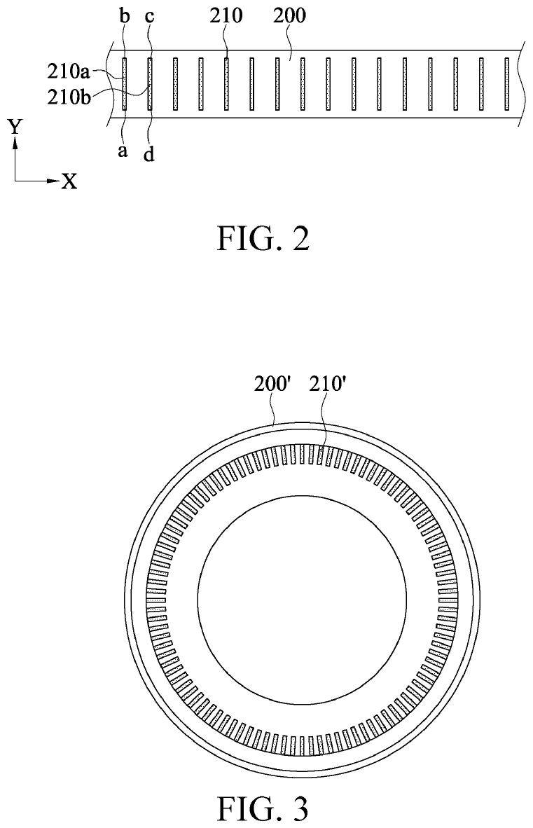

The processing herein refers to forming a plurality of scale lines 210 on the workpiece 200. FIG. 2 is a partially enlarged schematic diagram of a strip-shaped workpiece 200 according to an embodiment of the present invention. The scale lines 210 are in a parallel alignment with equal spacing, but this embodiment of the present invention is not limited thereto. The workpiece 200 herein is metallic. The laser beam L is a deep ultraviolet laser beam, but this embodiment of the present invention is not limited thereto. This depends on the material quality and the process quality requirement of the workpiece 200. For example, the laser beam L may be an infrared laser beam, a green laser beam, an ultraviolet laser beam, and the like. The pulse width level of the laser beam L may be nanosecond (ns), picosecond (ps), and femtosecond (fs). The energy of the laser beam L depends on the processing requirement.

In an embodiment, the laser beam L forms the scale lines 210 in a direct writing manner. For example, as shown in FIG. 2, when the laser beam L processes from a point a, the motion platform 120 moves along a direction Y, so that the laser beam L processes along the direction Y and moves to a point b, thereby forming the first scale line 210a. Then, the motion platform 120 further moves along a direction X, so that the laser unit 110 is aligned with a point c. In a moving process from the point b to the point c, the laser beam L does not output. Then, the laser unit 110 outputs the laser beam L, and the motion platform 120 moves along a direction opposite to the direction Y, so that a processing location of the laser beam L moves from the point c to the point d, thereby forming the second scale line 210b. In some embodiments, after completing the first scale line 210a, the laser unit 110 may be aligned with the point d, so that the processing location of the laser beam L moves the point d to the point c.

In an embodiment, the laser unit 110 outputs the laser beam L in a scanning manner to form one scale line 210 during each scan, and moves to a location of a next scale line 210 through the motion platform 120. Specifically, as shown in FIG. 2, when processing the first scale line 210a, the laser unit 110 is aligned with a preset location of the scale line 210a. However, in this embodiment, the laser unit 110 has a galvo scanner to change a travel direction of the laser beam L, so that a focusing location of the laser beam L is moved from the point a to the point b, thereby forming the scale line 210a. In some embodiments, the focusing location may be moved from the point b to the point a. Then, the motion platform 120 moves along the direction X, so that the laser unit 110 is aligned with a preset location of the second scale line 210b. Similarly, the laser unit 110 may change the travel direction of the laser beam L in a scanning manner, so that the focusing location of the laser beam L is moved from the point c to the point d to form the scale line 210b. In some embodiments, the focusing location of the laser beam L may be moved from the point d to the point c.

In some embodiments, as shown in FIG. 1, the laser processing device 100 may further include a visual alignment module 150. The visual alignment module 150 includes an imaging lens group and an image detector (not shown). The visual alignment module 150 may be an automated optical inspection (AOI) device. The image detector detects light passing through the imaging lens group and converts the light into a corresponding image signal. The image detector is electrically connected to the control unit 130 and transmits the image signal to the control unit 130. Therefore, the control unit 130 may obtain an image of the processing area A and aligns a next segment S based on the image. Specifically, after one segment S is processed, the control unit 130 drives the conveyor wheel set 140 to roll the strip-shaped workpiece 200, so that the processed segment S is moved out of the processing area A. Before the next segment S is processed, the control unit 130 may achieve alignment through the visual alignment module 150, so that the laser unit 110 may be accurately aligned with a next location to form the scale line 210. This controls spacing between the last scale line 210 of a previous segment S and the first scale line 210 of a current segment S, so as to be consistent with spacing between other scale lines 210.

In some embodiments, after one scale line 210 is processed, the visual alignment module 150 may be further used to align the laser unit 110 with a location of the next scale line 210 to be processed, but is not limited to connect the neighboring two segments S.

In some embodiments, as shown in FIG. 1, the laser processing device 100 may further include a suction device 160 such as a vacuum chuck. The suction device 160 is electrically connected to the control unit 130, so that the control unit 130 may control enabling strength, inhibiting strength or suction strength. When enabling, the suction device 160 may fasten the segment S of the strip-shaped workpiece 200 by suction, so that the segment S of the workpiece 200 maintains flat.

In some embodiments, as shown in FIG. 1, the laser processing device 100 may further include a double-sided laminating wheel set 170 electrically connected to the control unit 130, so as to be controlled to rotate forward or backward by the control unit 130. The conveyor wheel set 140 conveys a processed segment S of the strip-shaped workpiece 200 out of the processing area A. The double-sided laminating wheel set 170 separately applies a laminar film on a side surface and an opposite side surface that have the scale lines 210 and that are on the segment S of the strip-shaped workpiece 200 out of the processing area A. The film on the side surface having the scale lines 210 is a protection film 300. The protection film 300 may be a flexible material such as PE, PP, and the like. The film on the opposite side surface having the scale lines 210 is an adhesive film 400 (such as a double-sided adhesive tape) providing an adhesive function. The processed strip-shaped workpiece 200 becomes a roll of finished product 500. A user may cut a part with appropriate length. When using, the cutting part may be adhered to a required position with the adhesive film 400, and the protection film 300 may be torn off, which may be used as an accurate scale.

FIG. 3 is a top view of a disc-shaped workpiece 200′ according to an embodiment of the present invention. In this embodiment, the workpiece 200′ may be directly disposed in the processing area A, and the laser unit 110 is moved by the motion platform 120 to process the workpiece 200′. The scale lines 210′ formed herein are in a radial alignment for an accurate angle measurement. In some embodiments, the disc-shaped workpiece 200′ may be a motor.

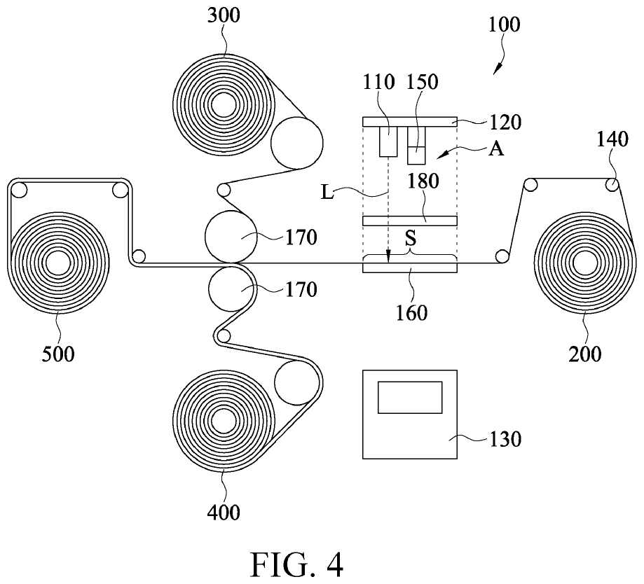

FIG. 4 is a schematic architectural diagram of a laser processing device 100 for making a metrological scale according to another embodiment of the present invention. In some embodiments, the laser processing device 100 may further include a mask 180 disposed in the processing area A, so that the entire segment S of the workpiece 200 is processed in one step by a portion of the laser beam L passing through the mask 180 (that is, in an exposure manner through the mask 180). The laser beam L herein is a deep ultraviolet laser beam, but this embodiment of the present invention is not limited thereto, which depends on the material quality and the process quality requirement of the workpiece 200. For example, the laser beam L may be an infrared laser beam, a green laser beam, an ultraviolet laser beam, and the like. The pulse width of the laser beam L may be nanosecond (ns), picosecond (ps), and femtosecond (fs). The energy of the laser beam L depends on the processing requirement.

In some embodiments, the laser processing device 100 further includes a cleaning device (not shown) arranged behind the processing area, to clean (such as ultrasound washing and solvent washing) and dry the processed area. The workpiece 200 is rolled and is adhered with the protection film 300 and the adhesive film 400 by the double-sided laminating wheel set 170 after cleaning.

In some embodiments, the visual alignment module 150 checks the processed area, to detect the yield of the processed area and label an area with poor yield through the laser unit 110.

In some embodiments, the laser unit 110 may pre-polish the workpiece 200 before the foregoing laser processing.

Based on the above, the embodiments of the present invention provide a laser processing device 100 for making a metrological scale, to accurately process the workpieces 200 and 200′.

What is claimed is:

1. A laser processing device for making a metrological scale, adapted to process a workpiece, wherein the laser processing device comprises:
a laser unit, configured to output a laser beam;
a motion platform, bearing the laser unit; and
a control unit, electrically connected to the laser unit and the motion platform, to control the motion platform to move relative to the workpiece and trigger the laser unit to output the laser beam at a suitable location, so that the workpiece is processed with a plurality of scale lines.

2. The laser processing device for making a metrological scale according to claim 1, wherein the laser processing device has a processing area, the workpiece is a strip, and the laser processing device further comprises:
a conveyor wheel set, electrically connected to the control unit for conveying the strip to pass through the processing area, so that a segment of the strip located in the processing area is processed with the scale lines.

3. The laser processing device for making a metrological scale according to claim 1, wherein the laser beam forms the scale lines in a direct writing manner.

4. The laser processing device for making a metrological scale according to claim 2, wherein the laser beam forms the scale lines in a direct writing manner.

5. The laser processing device for making a metrological scale according to claim 1, wherein the laser unit outputs the laser beam in a scanning manner to form one scale line during each scan, and moves to a location of a next scale line through the motion platform.

6. The laser processing device for making a metrological scale according to claim 2, wherein the laser unit outputs the laser beam in a scanning manner to form one scale line during each scan, and moves to a location of a next scale line through the motion platform.

7. The laser processing device for making a metrological scale according to claim 1, further comprising a mask disposed in the processing area, so that the workpiece is processed by a portion of the laser beam passing through the mask.

8. The laser processing device for making a metrological scale according to claim 7, wherein the laser beam is a deep ultraviolet laser beam.

9. The laser processing device for making a metrological scale according to claim 2, further comprising a mask disposed in the processing area, so that the workpiece is processed by a portion of the laser beam passing through the mask.

10. The laser processing device for making a metrological scale according to claim 9, wherein the laser beam is a deep ultraviolet laser beam.

11. The laser processing device for making a metrological scale according to claim 1, further comprising a visual alignment module electrically connected to the control unit, to obtain an image of the processing area for the control unit to align the next segment.

12. The laser processing device for making a metrological scale according to claim 2, further comprising a visual alignment module electrically connected to the control unit, to obtain an image of the processing area for the control unit to align the next segment.

13. The laser processing device for making a metrological scale according to claim 2, further comprising a suction device electrically connected to the control unit, to fasten the segment of the strip by suction.

14. The laser processing device for making a metrological scale according to claim 2, further comprising a double-sided laminating wheel set electrically connected to the control unit, wherein the conveyor wheel set conveys a processed segment of the strip out of the processing area, and the double-sided laminating wheel set separately applies a laminar film on a side surface and an opposite side surface that have the scale lines and that are on the segment of the strip out of the processing area.

15. The laser processing device for making a metrological scale according to claim 14, wherein the laminar film on the side surface having the scale lines is a protection film.

16. The laser processing device for making a metrological scale according to claim 14, wherein the laminar film on the opposite side surface having the scale lines is an adhesive film.

17. The laser processing device for making a metrological scale according to claim 1, wherein the scale lines are in a parallel alignment.

18. The laser processing device for making a metrological scale according to claim 2, wherein the scale lines are in a parallel alignment.

19. The laser processing device for making a metrological scale according to claim 1, wherein the scale lines are in a radial alignment.
